(19) United States
(12) Patent Application Publication
(10) Pub. No.: US 2010/0018963 A1
(43) Pub. Date: Jan. 28, 2010

(54) Method for protecting a heating element, and heating device

(75) Inventors: Michael Rosenbauer, Reimlingen (DE); Peter Schweier, Forheim (DE); Franz-Josef Wagner, Nordlingen (DE); Christian Wirth, Dillingen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, Munchen (DE)

(21) Appl. No.: 12/311,597

(22) PCT Filed: Oct. 17, 2007
(86) PCT No.: PCT/EP2007/061078

§ 371 Date: Apr. 3, 2009

(30) Foreign Application Priority Data
Oct. 19, 2006 (DE) 10 2006 049 395.8

(51) Int. Cl. H05B 3/02

(52) U.S. Cl. 219/488

(57) ABSTRACT

A method for protecting a heating element with at least one voltage tap against overheating, the method including determining a heating element limit value, determining at least one voltage tap limit value, detecting a heating element value and at least one voltage tap value, and deactivating the heating element when one of the heating element value exceeds the heating element limit value, and the at least one voltage tap value exceeds the at least one voltage tap limit value.

The invention relates to a method for protecting a heating element with at least one voltage tap against overheating. The invention also relates to a heating device and a water-conducting domestic appliance with this type of heating device.

Heating devices with an electrically operated resistance heating element require protection against overheating, particularly if they are used in water-conducting domestic appliances such as water boilers, coffee machines, dishwashers or washing machines for example. In this situation, in order to provide protection against overheating the heating resistance is ascertained during the heating operation by measuring the heating current and voltage, and the heating is switched off if a fixed limit value is exceeded. This does however require very precise measurement, with long-term stability, of heating current and voltage. Furthermore, the heating resistances used for manufacturing can exhibit only a small manufacturing tolerance in order to allow implementation of a current measuring facility having the requisite accuracy. Problematical however are instances of critical partial overheating affecting relatively small surface areas, which can likewise result in destruction of the heating element. This is because they cannot be differentiated from noncritical warming affecting large surface areas.

The object of the invention is therefore to provide an improved method for protecting a heating element, which is neutral in respect of manufacturing tolerances, can be implemented with little outlay and permits the reliable detection of partial overheating.

The object of the invention is achieved by a method for protecting a heating element with at least one voltage tap against overheating, comprising the steps:
determination of a heating element limit value,
determination of at least one voltage tap limit value,
detection of the heating element value and the at least one voltage tap value, and
deactivation of the heating element if the heating element limit value or the at least one voltage tap limit value is exceeded.

In this case, the method according to the invention utilizes the fact that further characteristic values for the heating element are detected by means of a heating element with at least one voltage tap, and used for evaluation purposes. In this situation, the detection of the heating element value and of the at least one voltage tap value occurring continuously or at a preset sampling frequency means that it is also possible to reliably recognize instances of partial overheating. Furthermore, the influence of manufacturing tolerances is also eliminated by the method.

Provision is preferably made in this situation such that at least one resistance value is used for the purpose of limit value determination. Here, this can be the resistance value of the heating element, which is determined by means of a monitoring facility from the electric current flowing through the heating element and the electrical voltage dropping at the heating element. This resistance value is then monitored and compared, continuously or at a preset sampling frequency during operation, with the previously determined and saved heating element limit value, whereby the heating element is deactivated if the determined heating element limit value is exceeded. Instead of using a resistance value, it is alternatively also possible to use the conductance value.

Provision is furthermore preferably made such that at least one voltage ratio is used for the purpose of limit value determination. In this situation, the voltage ratio is the ratio of the voltage drop across the at least one voltage tap and the voltage drop across the heating element. If a plurality of voltage taps is provided on the heating element, depending on the number of voltage taps a corresponding number of voltage ratios is determined in relation to the voltage drop at the heating element. During operation, the respective voltages dropping at the voltage taps are detected continuously or at a preset sampling frequency by means of the monitoring facilities and compared with previously determined voltage tap limit values. As soon as a value exceeds a preset voltage tap limit, the heating element is deactivated.

Provision is thereby made in a preferred embodiment such that the steps
determination of a heating element limit value, and
determination of at least one voltage tap limit value
   take place in an initialization step. In other words, in its new state the heating device is heated up during the initialization step in the manufacturing process and a self-calibration takes place, wherein the electric current flowing through the heating element, the electrical voltage dropping across the heating element and also the electrical voltages dropping at the voltage taps are detected. In a next step, the corresponding limit values, in other words the heating element limit value and the at least one voltage tap limit value, are formed from these determined measurement values and saved. A multiplication by a correction factor can be provided in this situation in order to increase the reliability. The monitoring facility is then switched over to a monitoring mode in which only the detection of the heating element limit value and of the at least one voltage tap limit value occur continuously or at a preset sampling frequency, and the heating element is deactivated if a limit value is exceeded.

The invention also includes a heating device, comprising at least one heating element with at least one voltage tap and with a monitoring facility for monitoring the heating element, which is designed in such a manner that the heating device is deactivated in response to at least one preset limit value being exceeded. This device makes it possible in a simple manner by providing an additional voltage tap to reliably detect instances of partial overheating and at the same time to compensate for manufacturing tolerances in the components used by means of comparisons with preset limit values.

To this end, provision is preferably made such that the at least one preset limit value is a resistance value which is detected by means of a current and voltage measurement. This can for example be the heating element limit value for the heating element of the heating device. Similarly, the corresponding conductance value may also be used.

Provision is furthermore preferably made such that the at least one preset limit value is a voltage ratio which is formed from the electrical voltage dropping at the heating element and the electrical voltage dropping at the at least one voltage tap. With regard to the preset limit value, this can for example be the at least one voltage tap limit value.

Provision is made in a preferred embodiment such that the heating device has current measuring means for detecting the electrical current flowing through the heating element in order to thus ascertain the resistance value of the heating element. In this situation the current measurement is performed by measuring a voltage drop across a shunt resistance.

Provision is furthermore preferably made such that the monitoring facility has a memory in which the at least one preset limit value can be saved. This makes it possible in an initialization operation, for example, to detect a heating element limit value and at least one voltage tap limit value and to determine from these the respective limit values which can then be saved in the memory. On completion of the initialization operation, a microcontroller in a monitoring facility then has access to the saved limit value in order to be able to perform a comparison with the heating element values detected continuously or at a preset sampling frequency and the at least one voltage tap value.

The invention also includes a water-conducting domestic appliance, such as a water boiler, coffee machine, dishwasher or washing machine for example, which has at least one heating device according to the invention.

The invention will be described in the following with reference to a drawing. In the drawing:

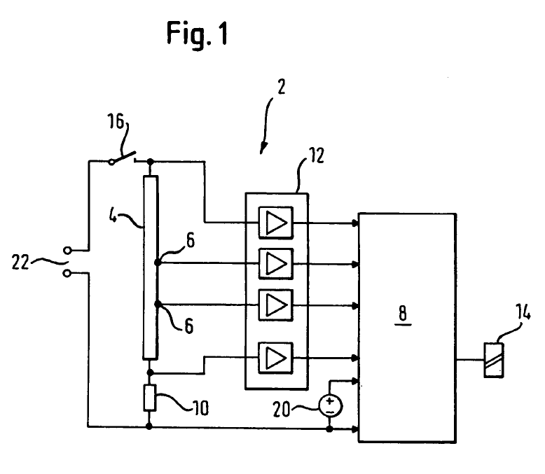

FIG. 1 shows a schematic illustration of a heating device according to the invention.

The heating device 2 according to the invention has a heating element 4, which is an electrical heating element in thick film technology having an essentially elongated form. In the present exemplary embodiment, the heating element 4 has two voltage taps 6. Alternatively, a different number of voltage taps can however also be provided.

The heating device 2 has a connection 22 for the supply of electrical energy which flows through the heating element 4 when the relay switch 16 is closed. A shunt resistance 10, which is used for current measurement of the electrical current flowing through the heating element 4, is arranged in series with the heating element 4.

The heating device 2 also includes a transducer unit 12 which is used for adapting the input voltage of the heating element 4, the voltage drop across the shunt resistance 10 and also the voltage drops across the voltage taps 6.

In addition, the heating device 2 comprises a monitoring facility 8 which has a microcontroller (not shown) and a memory (not shown). The microcontroller is connected on the input side to the voltage converter unit 8 and on the output side has an operative connection to a relay 14. The monitoring facility 8 is also connected to a reference voltage source 20.

The mode of operation of the heating device 2 according to the invention will now be described in the following.

In an initialization step, after an operating voltage has been applied to the connection 22 the voltage drop across the heating element 4 is first detected, as is also the electrical current flowing through the heating element 4, by means of the shunt resistance 10. After being adapted by the transducer unit 12, these values are delivered to the monitoring facility 8 with the microcontroller and from them is ascertained a limit value for the resistance value. In this situation, the limit value ascertained by measurement techniques can be multiplied by a preset correction factor. This value is then saved in the memory as a preset heating element limit value.

In a next step, the values for the voltage drops are detected at the voltage taps 6, adapted by means of the transducer unit 12 and delivered to the monitoring unit 8 with the microcontroller. A voltage ratio in relation to the voltage drop across the heating element 4 is subsequently determined for each voltage tap 6 and saved in the memory as voltage tap limit values, whereby a multiplication by a preset correction factor can likewise be provided. In addition, it is possible for the voltage ratio of the two voltage taps 6 to be formed and saved as a further limit value. The initialization operation is thus completed.

During operation, however, the heating device 2 is again supplied with electrical energy through a voltage source connected to the connection 22, which when the relay switch 16 is closed causes an electrical current to flow through the heating element, which causes heating of the heating element 4. The current flowing through the heating element 4 by means of the shunt resistance 10 and the voltage dropping across the heating element 4 are detected continuously or at a preset sampling frequency by means of the transducer unit 12 and the monitoring facility 8. Subsequently, from the electrical current flowing through the heating element 4 and the electrical voltage dropping at the heating element 4 is ascertained the current resistance value which is compared with the heating element limit value determined and saved during the initialization step. If the current resistance value is greater than the preset heating element limit value, the monitoring facility prevents current from being supplied to the relay 14, causing the relay switch 16 to open and thus disconnect the heating element 4 from the voltage supply.

Furthermore, the voltage drops at the voltage taps 6 are detected continuously or at a preset sampling frequency and the ratios of the voltages at the voltage taps 6 to the voltage dropping at the heating element 4 are formed. In addition, the ratios of the two voltages at the voltage taps 6 can also be formed. These are compared with the saved preset voltage tap limit values. If one of the current voltage tap limit values exceeds the corresponding preset voltage tap value, the monitoring facility 8 similarly prevents an electrical current from flowing through the relay 14 any longer, causing the relay switch 16 to open and disconnect the heating resistance 4 from the voltage supply.

The heating device according to the invention thus offers reliable protection for the heating element against overheating.

### LIST OF REFERENCE CHARACTERS

2 Heating device
4 Heating element
6 Voltage tap
8 Voltage facility
10 Shunt resistance
12 Converter unit
14 Relay
16 Relay switch
20 Reference voltage
22 Connection

1-11. (canceled)

12. A method for protecting a heating element with at least one voltage tap against overheating, the method comprising:
determining a heating element limit value;
determining at least one voltage tap limit value;
detecting a heating element value and at least one voltage tap value; and
deactivating the heating element when one of:
the heating element value exceeds the heating element limit value, and
the at least one voltage tap value exceeds the at least one voltage tap limit value.

13. The method of claim 12, wherein one of the heating element limit value and the at least one voltage tap limit value is determined based on at least one resistance value.

14. The method of claim 12, wherein one of the heating element limit value and the at least one voltage tap limit value is determined based on at least one voltage ratio.

15. The method of claim 12, comprising:
initializing the heating element,
wherein the initializing includes the determining the heating element limit value and the determining the at least one voltage tap limit value.

16. A heating device, comprising:
at least one heating element having at least one voltage tap; and
a monitoring facility for monitoring the heating element,
wherein the heating device is deactivated in response to at least one preset limit value being exceeded.

17. The heating device of claim 16, wherein the at least one preset limit value is a resistance value.

18. The heating device of claim 16, wherein the at least one preset limit value is a voltage ratio.

19. The heating device of claim 16, comprising:
current measuring means for detecting an electrical current flowing through the heating element.

20. The heating device of claim 16, wherein the at least one preset limit value is determined in an initialization step.

21. The heating device of claim 16, wherein the monitoring facility includes a memory that stores the at least one preset limit value.

22. The water-conducting domestic appliance including the heating device of claim 16.

23. The method of claim 12, wherein one of the heating element limit value and the at least one voltage tap limit value is determined based on at least one conductance value.

24. The heating device of claim 16, wherein the at least one preset limit value is a conductance value.
